(19) United States
(12) Patent Application Publication
(10) Pub. No.: US 2024/0029635 A1
(43) Pub. Date: Jan. 25, 2024

(54) POWER SUPPLY CIRCUIT, CHIP AND DISPLAY SCREEN

(71) Applicant: CHIPONE TECHNOLOGY (BEIJING) CO., LTD., Beijing (CN)

(72) Inventor: Yingjie MA, Beijing (CN)

(21) Appl. No.: 18/256,436

(22) PCT Filed: Nov. 15, 2021
(86) PCT No.: PCT/CN2021/130747

§ 371 Date: Jun. 8, 2023

(30) Foreign Application Priority Data
Dec. 17, 2020 (CN) 202011501641.7

(51) Int. Cl. G09G 3/32

(52) U.S. Cl. CPC G09G 3/32; G09G 2310/0291

(57) ABSTRACT

Provided are power supply circuit, chip, and display screen. The circuit includes: reference circuit configured to generate first-stage mirror current; first current mirror group connected to the reference circuit; first switch connected to the first current mirror group and configured to control turning-on or turning-off of the first current mirror group; second current mirror group connected to the first current mirror group; second switch connected to the second current mirror group and configured to control turning-on or turning-off of the second current mirror group, when the first switch and the second switch are turned on, the first current mirror group and the second current mirror group cooperating to form current mirror, which is configured to perform mirror processing on the first-level mirror current, so as to obtain an output current; and an output stage connected to the second current mirror group and configured to output the output current.

### CROSS-REFERENCE TO RELATED APPLICATION

The present disclosure claims the priority to the Chinese patent application with the filling No. 2020115016417 filed with the Chinese Patent Office on Dec. 17, 2020, and entitled “Power Supply Circuit, Chip and Display Screen”, the contents of which are incorporated herein by reference in its entirety.

### TECHNICAL FIELD

The present disclosure relates to the technical field of circuits, in particular to a power supply circuit, a chip, and a display screen.

### BACKGROUND ART

LED (Light Emitting Diode) display screen is a type of flat-panel display that is composed of small LED module panels, which is a kind of equipment for displaying various information such as words, images, and videos. LED display screen integrates microelectronics technology, computer technology, and information processing technology; and has the advantages of bright colors, wide dynamic range, high brightness, long lifespan, working stably and reliably, and so on. Based on this, the LED display screen is widely used in various occasions such as commercial media, cultural performance markets, stadiums, information dissemination, press release, and securities transactions, meeting the needs of different environments.

LED display screen requires a driver chip to display. However, the current precision of the existing driver chip circuit is usually not high, which cannot meet the demand.

### SUMMARY

The purpose of the embodiment in the present disclosure is to provide a power supply circuit, a chip, and a display screen.

The embodiment of the present disclosure provides a power supply circuit, which comprises a reference circuit, configured to generate a first-stage mirror current; a first current mirror group, connected to the reference circuit; a first switch, connected to the first current mirror group and configured to control the closing and opening of the first current mirror group; a second current mirror group, connected to the first current mirror group; a second switch, connected to the second current mirror group and configured to control the closing and opening of the second current mirror group, wherein when the first switch and the second switch are closed, the first current mirror group and the second current mirror group cooperate to form a current mirror, which is configured to perform mirror processing on the first-stage mirror current, to obtain an output current; and an output stage, connected to the second current mirror group and configured to output the output current.

Optionally, the first current mirror group comprises: a first amplifier, wherein an inverting input terminal of the first amplifier is connected to the preset voltage signal; a plurality of first triodes, wherein the drain of each first triode is connected to a non-inverting input terminal of the first amplifier, respectively; the gates of the first triodes are connected to the output terminal of the first amplifier through the first switch; and the sources of the first triodes are grounded.

Optionally, the first switch comprises a plurality of first sub-switches, wherein the gate of each first triode is respectively connected to one terminal of the first sub-switch, and the other terminal of the first sub-switch is connected to the output terminal of the first amplifier.

Optionally, the second current mirror group comprises: a second amplifier, wherein a non-inverting input terminal of the second amplifier is connected to the drain of the first triode, and the output terminal of the second amplifier is connected to the output stage; and a plurality of second triodes, wherein the drain of each second triode is respectively connected to the inverting input terminal of the second amplifier, the gates of the second triodes are connected to the output terminal of the first amplifier through the second switch, and the source of the second triode is grounded.

Optionally, the second triode is an NMOS device.

Optionally, the second switch comprises a plurality of second sub-switches, wherein the gate of each second triode is respectively connected to one terminal of the second sub-switch, and the other terminal of the second sub-switch is connected to the output terminal of the first amplifier.

Optionally, a buffer is also included, which is connected between the first current mirror group and the second current mirror group.

Optionally, the reference circuit comprises: a reference amplifier, wherein the inverting input terminal of the reference amplifier receives the reference signal; and an external resistor, wherein the first terminal of the external resistor is connected to the non-inverting input terminal of the reference amplifier, and a second terminal of the external resistor is grounded.

Optionally, the reference circuit further comprises: a third triode, wherein the gate of the third triode is connected to the output terminal of the reference amplifier, the drain of the third triode is connected to the first terminal of the external resistor, and the source of the third triode is grounded; and a fourth triode, wherein the gate of the fourth triode is connected to the output terminal of the reference amplifier, the drain of the fourth triode is respectively connected to the drain of each of the first triodes, and the source of the fourth triode is grounded.

Optionally, the output stage comprises a fifth triode, wherein the gate of the fifth triode is connected to the output terminal of the second amplifier, the source of the fifth triode is connected to the drain of each of the second triodes, respectively, and the drain of the fifth triode is connected to the circuit to be driven.

Optionally, a controller is also included, which is connected to the first switch and the second switch, respectively, wherein the controller is configured to send a control signal to the first switch and the second switch.

The embodiment of the present disclosure further provides a driver chip, comprising the power supply circuit provided in the embodiment of the present disclosure.

Optionally, the driver chip is a driver chip of an LED display screen.

The embodiment of the present disclosure also provides a display screen, comprising the power supply circuit provided in the embodiment of the present disclosure, wherein the common anode of the power supply circuit drives the display screen; or the common cathode of the power supply circuit drives the display screen.

Optionally, the display screen is an LED display screen.

The present disclosure provides a power supply circuit, a chip, and a display screen. A first switch for the first current mirror group and a second switch for the second current mirror group are provided to respectively control the opening and closing of the two current mirror groups, and when the first switch and the second switch are closed, the first current mirror group and the second current mirror group cooperate to form a current mirror, which performs the mirror processing on the first-stage mirror current generated by the basic circuit, to obtain an output current, in which the output current is output as a constant-current source through the output stage. In this way, the influence of output current accuracy by the switch outputting the constant-current source is reduced, the stability of the internal loop is improved, and the current accuracy in the whole current range of the output constant-current source is effectively promoted.

### BRIEF DESCRIPTION OF DRAWINGS

To more clearly illustrate the technical solutions of the embodiments of the present disclosure, the drawings used in the embodiments will be briefly introduced below. It should be understood that the following drawings only show some embodiments of the present disclosure, and therefore should not be regarded as a limitation on the scope. Those of ordinary skill in the art can also obtain other related drawings based on these drawings without inventive effort.

FIG. 1A is a structural schematic view of a power supply circuit according to an embodiment of the present disclosure;

FIG. 1B is a structural schematic view of a power supply circuit according to an embodiment of the present disclosure;

FIG. 1C is a schematic view of the principle of a current mirror in an embodiment of the present disclosure;

FIG. 2 is a structural schematic view of a power supply circuit according to an embodiment of the present disclosure;

FIG. 3 is a structural schematic view of a power supply circuit according to an embodiment of the present disclosure;

FIG. 4A to 4C are schematic views of circuit equivalent structure of the constant-current-source output channels of the embodiment of the present disclosure.

### REFERENCE NUMERALS

1—power supply circuit, 10—reference circuit, 20—current mirror, 30—output circuit, 21—first current mirror group, 22—first switch, 23—second current mirror group, 24—second switch, 25—output stage, 26—buffer, 27—controller, OP1—first amplifier, NM0—first triode, K0—first sub-switch, NM1—second triode, K1—second sub-switch, OP0—reference amplifier, Rext—external resistor, PM0—third triode, PM1—fourth triode, DRIVER_OP—second amplifier, NM2—fifth triode, I0—reference current, I1—first-stage mirror current, Iout—output current, Vref—reference voltage, LED—light-emitting diode.

### DETAILED DESCRIPTION OF EMBODIMENTS

The technical solutions in the embodiments of the present disclosure will be described below referring to the drawings in the embodiments of the present disclosure. In the description of the present disclosure, the terms “first”, “second” and the like are only used for distinguishing descriptions, and cannot be understood as indicating or implying relative importance.

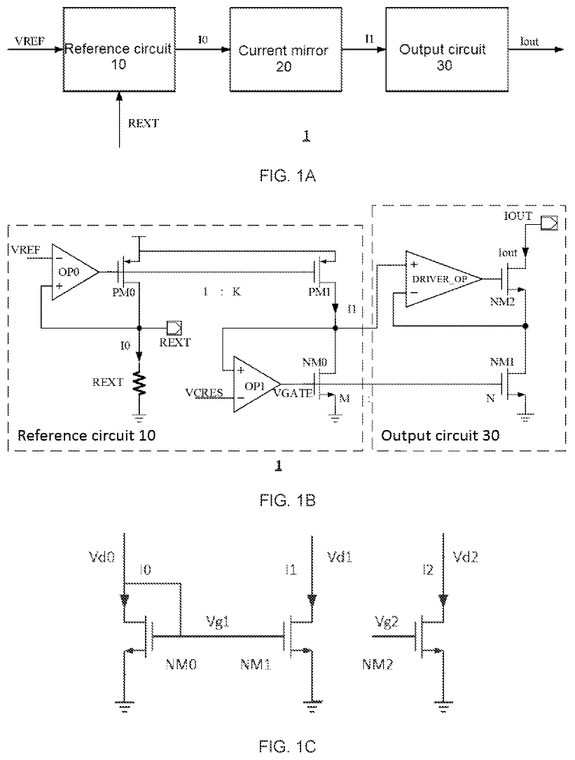

As shown in FIG. 1, the present embodiment provides a power supply circuit 1, which mainly comprises three parts: a reference circuit 10, a current mirror 20, and an output circuit 30. The aforesaid power supply circuit 1 may be applied to the driver chip of an LED display screen and configured as a constant-current-source generating circuit. The reference circuit 10 generates a reference current I0 by the internal reference voltage VREF and the external resistor Rext, and then the reference current I0 is processed by the current mirror 20 to obtain the current I1; finally, the output circuit 30 generates and drives the output constant-current source Iout. The current mirror 20 and the output circuit 30 need to adapt the common anode structure of the LED and meet the requirements of capability of multi-channel driving.

As shown in FIG. 1B, the embodiment provides a specific circuit diagram of a power supply circuit 1, comprising the reference voltage Vref generated by the bandgap reference voltage source in the chip, wherein the error amplifier OP0, triode PM0 and external resistor Rext are used to form a negative feedback structure, so as to obtain a reference current I0 as follows:

$$I 0 = \frac{Vref}{Rext}$$

Through the current mirror composed of the triode PM0 and the triode PM1, a precisely matched current I1 is obtained.

The aforesaid triode can adopt a MOS (Metal-Oxide-Semiconductor Field-Effect Transistor) device. In practical applications, the current of a MOS device is proportional to the size of the device under the same voltage bias. The current ratio is determined by the number of MOS devices, while adopting the MOS devices of the same size. The desired current ratio is acquired by adjusting the number of MOS devices. In this embodiment, an effect of a current mirror may be formed among the triode NM0, the triode NM1, and the triode NM2; and the principle of forming the current mirror 20 is detailed below.

The schematic view of current mirror 20 is shown in FIG. 1C, assuming that triode NM0 and triode NM1 are equipped with the same gate voltage Vg1, the gate voltage of triode NM2 is Vg2, and the drain voltages of triode NM0, triode NM1 and triode NM2 are Vd0, Vd1 and Vd2 respectively, if Vg1 is equal to Vg2 and Vd1 is equal to Vd2, the two devices, triode NM1 and triode NM2, are under the same bias condition, thus the current I1 is equal to the current I2, that is, the current I2 mirrors the current I1.

Based on the abovementioned principles, the current branch of the triode PM1 and the triode NM0 shown in FIG. 1B is satisfied with

I1=K·I0

where K is the mirror ratio of the triode PM1 to the triode NM0, which is determined by the performance of the selected devices. Then, using the negative feedback structure formed by the error amplifier OP1 and the triode NM0 to set the drain voltage VCRES of the triode NM0, a gate voltage VGATE of the triode NM0 is obtained. At the same time, to accurately mirror the output channel current Iout, the gate voltage of triode NM1 is required to be equal to VGATE, and the drain voltage is required to be equal to VCRES. By using a negative feedback loop formed by the amplifier DRIVER_OP and the triode NM2, the drain voltage of triode NM1 is set to be equal to the drain voltage of NM0. The driver chip of the LED in the common anode structure twice goes through current mirror, which has the following relationship:

$$I 1 = K \cdot I 0 \\ Iout = \frac{N}{M} \cdot I 1 \\ Iout = \frac{N \cdot K}{M} \cdot \frac{Vref}{Rext}$$

where the mirror ratio of the triode NM0 and the triode NM1 is M:N, so that the desired accurate output current Iout can be obtained by adjusting the external resistor Rext and the ratio of the current mirror.

In the above power supply circuit, the mirror ratio of the triode NM0 and the triode NM1 is M:N. It is necessary to select an appropriate value of ratio to reduce the branch current of the triode NM0 while maintaining the required current accuracy, thereby reasonably reducing the static power consumption of the chip.

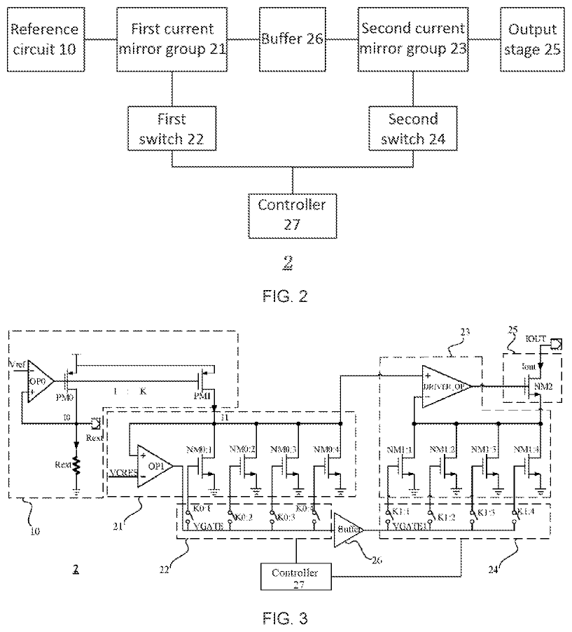

As shown in FIG. 2, the embodiment provides a power supply circuit 1, comprising a reference circuit 10, a first current mirror group 21, a first switch 22, a second current mirror group 23, a second switch 24, and an output stage 25, wherein
the reference circuit 10 is configured to generate a first-stage mirror current I1; the first current mirror group 21 is connected to the reference circuit 10; the first switch 22 is connected to the first current mirror group 21 and is configured to control closing and opening of the first current mirror group 21; the second current mirror group 23 is connected to the first current mirror group 21; the second switch 24 is connected to the second current mirror group 23 and is configured to control closing and opening of the second current mirror group 23, wherein when the first switch 22 and the second switch 24 are closed, the first current mirror group 21 and the second current mirror group 23 cooperate to form a current mirror, which is configured to perform mirror processing on the first-stage mirror current I1, so as to obtain an output current Iout; and the output stage 25 is connected to the second current mirror group 23 and is configured to output the output current Iout.

Optionally, a buffer 26 connected between the first current mirror group 21 and the second current mirror group 23 is further included. The buffer 26 may reduce the feedback noise, ensuring the current accuracy, and improving the stability of the negative feedback loop.

Optionally, a controller 27 connected to the first switch 22 and the second switch 24 respectively is also included, wherein the controller is configured to send a control signal to the first switch 22 and the second switch 24.

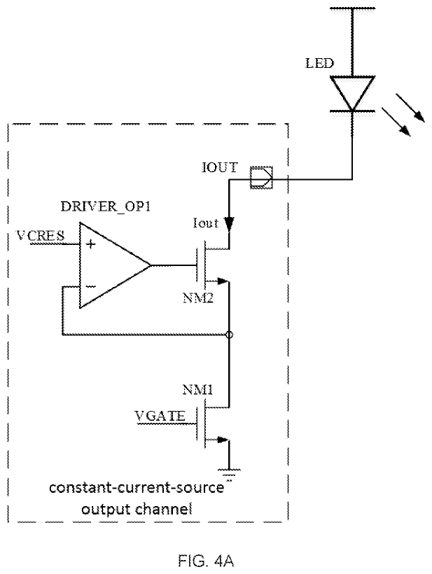

As shown in FIG. 3, the embodiment provides a power supply circuit 1, and the first current mirror group 21 comprises a first amplifier OP1 and a plurality of first triodes NM0, wherein an inverting input terminal of the first amplifier OP1 is connected to the preset voltage signal, and the drain of each first triode NM0 is connected to a non-inverting input terminal of the first amplifier OP1, respectively; the gate of the first triode NM0 is connected to an output terminal of the first amplifier OP1 through the first switch 22; and the source of the first triode NM0 is grounded. In FIG. 3, four first triodes NM0 are shown as an example.

Optionally, the first switch 22 comprises a plurality of first sub-switches K0, wherein the gate of each first triode NM0 is respectively connected to one terminal of the first sub-switch K0, and the other terminal of the first sub-switch K0 is connected to the output terminal of the first amplifier OP1.

Optionally, the second current mirror group 23 comprises a second amplifier DRIVER_OP and a plurality of second triodes NM1, wherein a non-inverting input terminal of the second amplifier DRIVER_OP is connected to the drain of the first triode NM0, and the output terminal of the second amplifier DRIVER_OP is connected to the output stage 25; and the drain of each second triode NM1 is respectively connected to the inverting input terminal of the second amplifier DRIVER_OP, the gates of the second triodes NM1 are connected to the output terminal of the first amplifier OP1 through the second switch 24, and the source of the second triode NM1 is grounded. In FIG. 3, four second triodes NM1 are shown as an example.

Optionally, the second switch 24 comprises a plurality of second sub-switches K1, wherein the gate of each second triode NM1 is respectively connected to one terminal of the second sub-switch K1, and the other terminal of the second sub-switch K1 is connected to the output terminal of the first amplifier OP1.

Optionally, a buffer 26 may be connected between the first current mirror group 21 and the second current mirror group 23.

Optionally, the reference circuit 10 comprises a reference amplifier OP0, wherein the inverting input terminal of the reference amplifier OP0 receives the reference signal, which may be the reference voltage Vref; and an external resistor Rext, wherein the first terminal of the external resistor Rext is connected to the non-inverting input terminal of the reference amplifier OP0 and the second terminal of external resistor Rext is grounded.

Optionally, the reference circuit 10 further comprises a third triode PM0, wherein the gate of the third triode PM0 is connected to the output terminal of the reference amplifier OP0, the drain of the third triode PM0 is connected to the first terminal of the external resistor Rext, and the source of the third triode PM0 is grounded; and a fourth triode PM1, wherein the gate of the fourth triode PM1 is connected to the output terminal of the reference amplifier OP0, the drain of the fourth triode PM1 is respectively connected to the drain of each first triode NM0, and the source of the fourth triode PM1 is grounded.

Optionally, the output stage 25 comprises a fifth triode NM2, wherein the gate of the fifth triode NM2 is connected to the output terminal of the second amplifier DRIVER_OP, the source of the fifth triode NM2 is respectively connected to the drain of each second triode NM1, and the drain of the fifth triode NM2 is connected to the circuit to be driven.

As shown in FIG. 3, to further clearly describe the principle of the power supply circuit 1 of this embodiment, assuming that there are four first triodes NM0 which are the triode NM0:1 to the triode NM0:4; four second triodes NM1 which are the triode NM1:1 to the triode NM1:4, four first switch 22 which are the first sub-switch K0:1 to the first sub-switch K0:4, and four second switch 24 which are the second sub-switch K1:1 to the second sub-switch K1:4, the detailed principle is described based on this as follows.

First, it is assumed that the mirror ratio N/M of the first current mirror group 21 and the second current mirror group 23 ranges from 4 to 8, the purpose of which is to reduce the power consumption of the chip while satisfying device performance.

Secondly, the voltage VGATE is sent to the gate of the second triode NM1 in the channel through a buffer 26. Compared with the manner of directly sending the voltage VGATE to the gate of the second triode NM1 in the channel, the buffer 26 isolates the constant-current-source generating circuit from the constant-current-source output channel, so as to avoid the impact of noise generated by the constant-current-source output channel being continually opened and closed on the constant-current source. In a multi-channel structure, the first amplifier OP1 needs to drive multiple second triodes NM1, and the second triodes NM1 can be NMOS (N-Metal-Oxide-Semiconductor), which contributes a large parasitic capacitance at the output node of the first amplifier OP1. Therefore, the buffer 26 not only improves the driving capability of the voltage VGATE but also reduces the design difficulty of the first amplifier OP1.

Finally, the first triode NM0 and the mirror current in the channel thereof in first current mirror group 21 are divided into four groups, wherein the control signals of the first sub-switch K0:1 and the second sub-switch K1:1 are identical, the control signals of the first sub-switch K0:2 and the second sub-switch K1:2 are identical, the control signals of the first sub-switch K0:3 and the second sub-switch K1:3 are identical, and the control signals of the first sub-switch K0:4 and the second sub-switch K1:4 are identical. The control signals of the aforesaid switches are given by the controller 27. In different scenarios, there are various requirements for the current configuration. The different current mirrors can be formed by each sub-switch turning on different groups of first triode NM0 and second triode NM1. Therefore, the accuracy of the constant-current source is improved under the premise that the range of the output current Iout is large. For ease of understanding, the principal is described as follows.

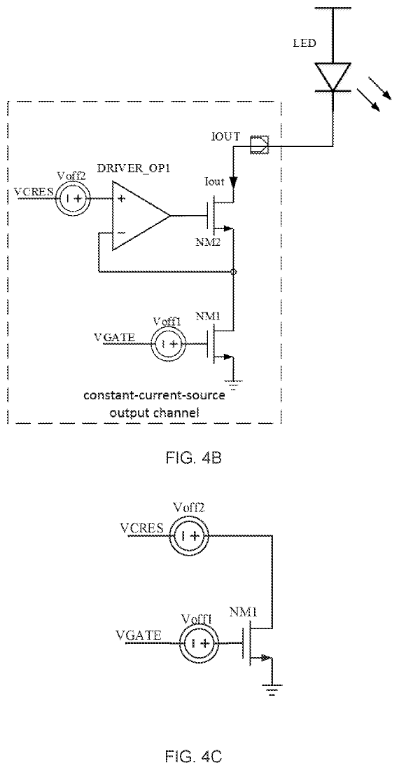

As shown in FIG. 4A to FIG. 4C, these are equivalent-circuit schematic views of the channel circuit outputting the constant-current source of power supply circuit 1 in the embodiment, wherein FIG. 4A shows the circuit diagram for connecting the output channel of the constant-current source and the light-emitting diode LED. Assuming that only the error introduced by the mismatch of the device is considered as the main error source of the constant-current source, there are two main error sources of the constant-current-source output channel: Voff1 (the equivalent offset voltage of the threshold voltage of the NMOS transistor that constitutes the current mirror) and Voff2 (the equivalent input offset voltage of DRIVER_OP1). The circuit shown in FIG. 4A can be equivalent to the equivalent circuit shown in FIG. 4B, and further, can be equivalent to the equivalent circuit shown in FIG. 4C; and then the current of the output constant-current source in FIG. 4A is equivalent to the current of the biased NMOS transistor shown in FIG. 4C.

In practical application, the relationship (ignoring some second-order effects) between the current of NMOS transistor and the voltages of its gate and drain satisfies the following formula:

$${I}_{DS} = μ {C}_{OX} \frac{W}{L} [ ( {V}_{GS} - {V}_{TH} ) {V}_{DS} - \frac{1}{2} {V}_{DS}^{2} ] \qquad ( 1 )$$

where μ is channel carrier mobility; C_{OX} is gate oxide-layer capacitance per unit area; W/L is the width to length ratio of MOS transistor; V_{GS} is the voltage between the gate and the source of MOS device; V_{DS} is the voltage between the drain and the source of MOS device; and V_{TH} is the threshold voltage of the MOS device.

The ratio

$$\frac{Δ {I}_{1}}{{I}_{DS}}$$

of the current error introduced by the voltage Voff1 to the drain-source current I_{DS} and the ratio

$$\frac{Δ {I}_{2}}{{I}_{DS}}$$

of the current error introduced by the voltage Voff2 to the drain-source current I_{DS} are calculated, respectively, then formula (2) and formula (3) can be obtained, the calculation process is as follows.

$$\begin{matrix}\frac{Δ {I}_{1}}{{I}_{DS}} = \frac{\partial {I}_{DS}}{\partial {V}_{GS}} \frac{{V}_{off 1}}{{I}_{DS}} \\ = \frac{μ {C}_{OX} \frac{W}{L} {V}_{DS} {V}_{off 1}}{μ {C}_{OX} \frac{W}{L} [ ( {V}_{GS} - {V}_{TH} ) {V}_{DS} - \frac{1}{2} {V}_{DS}^{2} ]} \\ = \frac{{V}_{off 1}}{{V}_{GS} - {V}_{TH} - \frac{1}{2} {V}_{DS}}\end{matrix} \\ \begin{matrix}\frac{Δ {I}_{2}}{{I}_{DS}} = \frac{\partial {I}_{DS}}{\partial {V}_{GS}} \frac{{V}_{off 2}}{{I}_{DS}} \\ = \frac{μ {C}_{OX} \frac{W}{L} ( {V}_{GS} - {V}_{TH} - {V}_{DS} ) {V}_{off 2}}{μ {C}_{OX} \frac{W}{L} [ ( {V}_{GS} - {V}_{TH} ) {V}_{DS} - \frac{1}{2} {V}_{DS}^{2} ]} \\ = \frac{( {V}_{GS} - {V}_{TH} - \frac{1}{2} {V}_{DS} ) {V}_{off 2} - \frac{1}{2} {V}_{DS} {V}_{off 2}}{( {V}_{GS} - {V}_{TH} - \frac{1}{2} {V}_{DS} ) {V}_{DS}}\end{matrix}$$

Therefore, the followings can be obtained.

$$\begin{matrix}\frac{Δ {I}_{1}}{{I}_{DS}} = \frac{{V}_{off 1}}{{V}_{GS} - {V}_{TH} - \frac{1}{2} {V}_{DS}} & ( 2 ) \\ \frac{Δ {I}_{2}}{{I}_{DS}} = \frac{{V}_{off 2}}{{V}_{DS}} - \frac{1}{2} \frac{{V}_{off 2}}{( {V}_{GS} - {V}_{TH} - \frac{1}{2} {V}_{DS} )} & ( 3 )\end{matrix}$$

Formulas (2) and (3) indicate that the greater the gate-source voltage of the second triode NM1 is, the smaller the impact of the error source introduced by the offset on the output current Iout is.

In practical application scenarios, in case that the channel current varies from a few milliamps to tens of milliamps, as the circuit connection state of the power supply circuit 1 during normal operation shown in FIG. 3, it can be obtained that V_{DS} remains unchanged and is equal to the internally set voltage VCRES. According to the formula (1), reducing W/L (that is, reducing the number of the second triodes NM1) is equivalent to increasing V_{GS} voltage. Therefore, when the output current Iout is small, only the first sub-switch K0:1 and the second sub-switch K1:1 are turned on, and the accuracy of the power supply circuit 1 at this time is the best. As the output current Iout increases and exceeds the capabilities of the first triode NM0:1 and the second triode NM1:1, the first sub-switch K0:2 and the second sub-switch K1:2 are turned on. In this way, as the set output current Iout increases, the first sub-switches K0:1 to K0:4 and the second sub-switches K1:1 to K1:4 are individually turned on, that is, less groups of NMOS devices are turned on when the output current Iout is small, thereby increasing the current accuracy of the chip.

In general, the current range of the constant-current source is large, from several milliamps to tens of milliamps. Adopting MOS devices of the same size in such a large range will lead to a large change on the current accuracy. Thus, the embodiment provides an idea of grouping: for different output current settings, different numbers of MOS transistors are turned on, thereby different groups adapt to different currents, which improves the current accuracy of the chip during the great variation of the current.

In the above power supply circuit 1, by selecting an appropriate mirror ratio M:N of the first triode NM0 to the second triode NM1, the static power consumption of the chip is reduced under the premise of ensuring the current accuracy. By adding a buffer 26 on the channel of the gate voltage VGATE of the current mirror NMOS transistor, the requirement for driving capability of the first amplifier OP1 is reduced, the feedback noise is decreased, and the current accuracy is ensured and meanwhile the stability of the negative feedback loop between the first amplifier OP1 and the first triode NM0 is improved. The constant-current source adopts the grouping mode, which effectively guarantees the current accuracy within the entire current range of the output constant-current source. The embodiment of the present disclosure further provides a driver chip comprising the power supply circuit 1 as mentioned in the above embodiment. Therefore, this embodiment has all the beneficial effects of the power supply circuit 1 in the above embodiment. For details, referring to the description of the above-mentioned embodiments, description will not be repeated herein. Optionally, the driver chip can be a driver chip of an LED display screen.

Further, the embodiment of the present disclosure provides a display screen comprising the power supply circuit 1 provided in the forgoing embodiment, wherein the common anode of the power supply circuit drives the display screen; or the common cathode of the power supply circuit drives the display screen. Therefore, this embodiment has all the beneficial effects of the power supply circuit 1 in the above embodiment. For details, referring to the description of the above-mentioned embodiments, description will not be repeated herein. Optionally, the display screen can be an LED display screen.

Although the embodiments of the present disclosure have been described in conjunction with the drawings, various modifications and variations can be made by those skilled in the art without departing from the spirit and scope of the present disclosure, and such modifications and variations fall within the scope defined by the appended claims.

### INDUSTRIAL PRACTICALITY

The technical solution provided by the present disclosure reduces the influence of the constant-current-source outputting switch on the output current accuracy, improves the stability of the internal loop, and effectively improves the current accuracy within the entire current range of the output constant-current source.

1. A power supply circuit, wherein the power supply circuit comprises:
a reference circuit, configured to generate a first-stage mirror current;
a first current mirror group, connected with the reference circuit;
a first switch, connected to the first current mirror group and configured to control closing or opening of the first current mirror group;
a second current mirror group, connected with the first current mirror group;
a second switch, connected to the second current mirror group and configured to control closing or opening of the first current mirror group, wherein
when the first switch and the second switch are closed, the first current mirror group and the second current mirror group cooperate to form a current mirror, which is configured to perform mirror processing on the first-stage mirror current, to obtain an output current; and
an output stage, connected to the second current mirror group and configured to output the output current.

2. The power supply circuit according to claim 1, wherein the first current mirror group comprises:
a first amplifier, wherein an inverting input terminal of the first amplifier is connected to a preset voltage signal; and
a plurality of first triodes, wherein a drain of each of the first triodes is connected to a non-inverting input terminal of the first amplifier, respectively; a gate of each of the first triodes is connected to an output terminal of the first amplifier through the first switch; and a source of each of the first triodes is grounded.

3. The power supply circuit according to claim 2, wherein the first switch comprises: a plurality of first sub-switches, wherein the gate of each of the first triodes is respectively connected to one terminal of a corresponding first sub-switch, and the other terminal of each of the first sub-switches is connected to the output terminal of the first amplifier.

4. The power supply circuit according to claim 2, wherein the second current mirror group comprises:
a second amplifier, wherein a non-inverting input terminal of the second amplifier is connected to the drain of each of the first triodes, and an output terminal of the second amplifier is connected to the output stage; and
a plurality of second triodes, wherein a drain of each of the second triodes is respectively connected to an inverting input terminal of the second amplifier, a gate of each of the second triodes are connected to the output terminal of the first amplifier through the second switch, and a source of each of the second triodes is grounded.

5. The power supply circuit according to claim 4, wherein the second triode is an NMOS device.

6. The power supply circuit according to claim 4, wherein the second switch comprises:
a plurality of second sub-switches, wherein the gate of each of the second triodes is respectively connected to one terminal of a corresponding second sub-switch, and the other terminal of each of the second sub-switches is connected to the output terminal of the first amplifier.

7. The power supply circuit according to claim 1, wherein the power supply circuit further comprises:
a buffer, connected between the first current mirror group and the second current mirror group.

8. The power supply circuit according to claim 2, wherein the reference circuit comprises:
a reference amplifier, wherein an inverting input terminal of the reference amplifier receives a reference signal; and
an external resistor, wherein a first terminal of the external resistor is connected to a non-inverting input terminal of the reference amplifier, and a second terminal of the external resistor is grounded.

9. The power supply circuit according to claim 8, wherein the reference circuit further comprises:
a third triode, wherein a gate of the third triode is connected to an output terminal of the reference amplifier, a drain of the third triode is connected to the first terminal of the external resistor, and a source of the third triode is grounded; and
a fourth triode, wherein a gate of the fourth triode is connected to the output terminal of the reference amplifier, a drain of the fourth triode is respectively connected to the drain of each of the first triodes, and a source of the fourth triode is grounded.

10. The power supply circuit according to claim 4, wherein the output stage comprises:
a fifth triode, wherein a gate of the fifth triode is connected to the output terminal of the second amplifier, a source of the fifth triode is respectively connected to the drain of each of the second triodes, and a drain of the fifth triode is connected to a circuit to be driven.

11. The power supply circuit according to claim 1, wherein the power supply circuit further comprises
a controller, connected to the first switch and the second switch, respectively, and configured to send a control signal to the first switch and the second switch.

12. A driver chip, wherein the driver chip comprises the power supply circuit according to claim 1.

13. The driver chip according to claim 12, wherein the driver chip is a driver chip of an LED display screen.

14. A display screen, wherein the display screen comprises the power supply circuit according to claim 1, wherein
a common anode of the power supply circuit drives the display screen; or
a common cathode of the power supply circuit drives the display screen.

15. The display screen according to claim 14, wherein the display screen is an LED display screen.

16. The power supply circuit according to claim 3, wherein the second current mirror group comprises:
a second amplifier, wherein a non-inverting input terminal of the second amplifier is connected to the drain of each of the first triodes, and an output terminal of the second amplifier is connected to the output stage; and
a plurality of second triodes, wherein a drain of each of the second triodes is respectively connected to an inverting input terminal of the second amplifier, a gate of each of the second triodes are connected to the output terminal of the first amplifier through the second switch, and a source of each of the second triodes is grounded.

17. The power supply circuit according to claim 5, wherein the second switch comprises:
a plurality of second sub-switches, wherein the gate of each of the second triodes is respectively connected to one terminal of a corresponding second sub-switch, and the other terminal of each of the second sub-switches is connected to the output terminal of the first amplifier.

18. The power supply circuit according to claim 2, wherein the power supply circuit further comprises:
a buffer, connected between the first current mirror group and the second current mirror group.

19. The power supply circuit according to claim 3, wherein the reference circuit comprises:
a reference amplifier, wherein an inverting input terminal of the reference amplifier receives a reference signal; and
an external resistor, wherein a first terminal of the external resistor is connected to a non-inverting input terminal of the reference amplifier, and a second terminal of the external resistor is grounded.

20. The power supply circuit according to claim 5, wherein the output stage comprises:
a fifth triode, wherein a gate of the fifth triode is connected to the output terminal of the second amplifier, a source of the fifth triode is respectively connected to the drain of each of the second triodes, and a drain of the fifth triode is connected to a circuit to be driven.
